(19) United States
(12) Patent Application Publication
(10) Pub. No.: US 2023/0216111 A1
(43) Pub. Date: Jul. 6, 2023

(54) PHOTOVOLTAIC REDUCTION OF WASTE CATIONS FROM ZINC AIR FUEL CELLS

(71) Applicant: Joel Steven Goldberg, Hillsborough, NC (US)

(72) Inventor: Joel Steven Goldberg, Hillsborough, NC (US)

(21) Appl. No.: 18/114,262

(22) Filed: Feb. 26, 2023

(51) Int. Cl. H01M 14/00

(52) U.S. Cl. CPC H01M 14/005

(57) ABSTRACT

This invention describes an affordable, renewable, sustainable (ARS) system to produce electricity, comprising a zinc air fuel cell (ZAFC) and photovoltaic cell. This ZAFC produces electricity operating in the pH range of 6.5-8.5 such that the primary waste species in the electrolyte are zinc cations of Zn⁺² and ZnOH⁺. These cations are reduced by electrons from photovoltaic cells, and this ZAFC is easily rechargeable with a photovoltaic cell, and it can be overcharged. Also the electrolyte can be separated from the cell, and plating with photo reduction of zinc occurs rapidly on graphite, copper, or zinc cathodes. The efficiency of the ZAFC is approximately 58%, plus the added efficiency of reclaimed reduced zinc cations to zinc, either through recharging or plating. The electrolyte can be seawater or saline. The raw materials for this ZAFC are sufficiently available such that this system could provide ARS electricity.

### CROSS-REFERENCES TO RELATED APPLICATIONS

This application claims the benefit of U.S. application Ser. No. 17/575,735 which is incorporated by reference.

### FEDERALLY FUNDED RESEARCH

Not applicable

### BACKGROUND OF THE INVENTION

### Energy Insecurity

Our society and its future generations depend upon affordable, renewable, and sustainable (ARS) electricity. Unless we can discover and develop methods to produce this electricity, our future and the future of our planet is vulnerable. The solution to fresh water and food insecurity, sustainable transportation, communication, and construction is ARS energy. Numerous conflicts and wars among nations have been initiated and fought over procurement of raw materials to produce electricity. The single most important accomplishment to produce peace among nations may be ARS energy.

### Overview of Present Methods to Produce Electricity:

1. The conversion of heat to electricity through the consumption of fossil or nuclear fuels, with transformations of heat to work, kinetic energy to electricity, and transmission through power lines is inefficient. Although electrical induction is a very efficient method to produce electricity there are hidden inefficiencies from friction, mechanical wear, and input electricity required to produce electromagnets in turbines.

2. The conversion of the kinetic energy from water or wind to electricity has transmission inefficiencies. The kinetic energy from wind is non-continuous with an efficiency Betz limit of approximately 60%.

3. The conversion of solar energy to electricity has inefficiencies within photovoltaic cells, which are non-continuous sources of electricity and require conversion of DC to AC current.

These inefficiencies do not include extraction and transportation of raw materials, construction and maintenance of power systems, and the environmental consequences of electricity production. Furthermore, present grid systems are vulnerable to weather conditions, terrorist attacks, and possibly electromagnetic pulses.

Most pundits in the field of electrical energy generation have not expressed an interest in ARS metal air fuel cells as a viable option for our planet's energy needs. This invention proposes a contrarian view.

Many energy-dense metal anodes spontaneously oxidize in aqueous solutions, and coupled with an oxygen reduction reaction (ORR) at the graphite cathode, can produce electricity. Of the common metals of tin, nickel, iron, copper, aluminum, magnesium, and zinc, tin and nickel are relatively non-reactive, and copper, aluminum, and iron form oxide coatings. Zinc and magnesium are the most promising metals for production of electricity from metal air fuel cells; however, unlike zinc, magnesium cannot be reclaimed through electrochemical plating, and magnesium air fuel cells are not rechargeable.

There is a plethora of literature describing zinc air fuel cells, nearly all of which focus on improving efficiency, including:

1. Changing anode material and configuration
2. Changing cathode material and configuration
3. Electrolyte additives
With each improvement that adds more components to the cell, the likelihood that the zinc air fuel will be ARS decreases.

The chemistry that describes a traditional zinc air fuel cell is:

| | |
|---|---|
| Anode: Zn + 4OH⁻ ↔ Zn(OH)₄²⁻ + 2e⁻ | E = 1.25 V |
| Cathode: ½ O2 + H₂O + 2e⁻ ↔ 2OH⁻ | E = 0.34 V |
| Overall: Zn + ½ O₂ ↔ ZnO | E = 1.59 V |

A previously described zinc air fuel cell comprised of a zinc anode, graphite cathode, and electrolyte of saline was quite durable with a specific energy of 193 Whr/kg. This zinc air fuel cell will be referred to as ZAFC. [1] The proposed chemistry that describes this ZAFC is:

| | |
|---|---|
| Anode: Zn ↔ Zn⁺² + 2e⁻ | E = 0.76 V |
| Cathode: ½ O₂ + H₂O + 2e− ↔ 2OH⁻ | E = 0.40 V |
| Overall: Zn + ½ O₂ + H₂0 ↔ Zn(OH)₂ | E = 1.16 V |

Producing Zn(OH)₂ as the primary waste product and at a pH of approximately 10, this ZAFC differs from most previously described zinc air fuel cells that include KOH or similar electrolytes and operate at a pH of approximately 13 with production of ZnO as the primary waste product. With a Kₛₚ of 10⁻¹⁷, Zn(OH)₂ precipitates in the cell and can be easily filtered and separated from the electrolyte, which can be recycled. This ZAFC showed no signs of dendritic growth, electrode carbonate deposition, or hydrogen evolution reactions.

It was proposed that the Zn(OH)₂ waste could be reclaimed through concentrated solar carbothermal reduction with the use of platinum as a catalytic converter of carbon monoxide driving the reaction toward products, according to the equation:

ZnO+C↔Zn+CO

However, after much investigation of the previously described cell, it was discovered that photovoltaic energy could recharge this ZAFC as it matures, within a pH range from approximately 6.5 to 8.5 and before large quantities of Zn(OH)₂ precipitate. Also the Zn⁺² and ZnOH⁺ waste could be electrochemically plated as zinc metal. Solar reclamation of Zn from ZnO in a rechargeable zinc air fuel cell has been reported with photo catalytic oxidation of an organic substance, but solar reduction of Zn⁺² and ZnOH⁺ waste from this ZAFC has not been reported, and the process is novel and not obvious. [2] In fact, most literature suggests that zinc air fuel cells are not readily rechargeable.

### Magnesium Air Fuel Cells (MAFC)

MAFC have many properties to consider as ARS fuel cells, including:

1. With electrolyte pH ranges of 8-9, Mg⁺² is the primary species, whereas in the ZAFC the mixed species are Zn⁺² and ZnOH⁺.
2. As a future metal for ARS energy, an unlimited supply of magnesium can be extracted from seawater, but the process is exceedingly energy intensive.
3. Magnesium cannot be readily reclaimed from Mg⁺² with recharging or electrochemical plating.

### DESCRIPTION OF THE DRAWINGS

FIG. 1 shows the relative concentrations of zinc species in aqueous solution at differing pH.

### DETAILED DESCRIPTION OF THE INVENTION

The electrolyte for this ZAFC is seawater or 0.1M-1.0 M NaCl. Possible ORR at the cathode include:

| | |
|---|---|
| O₂ + 2H₂O + 4e⁻ ↔ 4OH⁻ | E = 0.40 V |
| O₂ + 4H⁺ + 4e⁻ ↔ 2H₂0 | E = 1.23 V |
| O₂ + 2H⁺ + 2e⁻ ↔ H₂0₂ | E = 0.68 V |
| H₂O₂ → H₂O + ½ O₂ | |

Whether a single ORR occurs at the cathode or mixture, the net result will always be an increase in pH, either by the production OH⁻ or consumption of H⁺. These reactions are not completely equivalent as the consumption of H⁺ produces water. This tendency to increase pH will be attenuated by the hydration of atmospheric carbon dioxide in the electrolyte.

Surrounding the anode plate with graphite increases the surface area, dramatically improving the efficiency of the cell as measured by voltage and pH. The more efficient ORR, the slower the maturation of the fuel cell to precipitation of Zn(OH)₂ and slower rising of pH. This may occur from changes in [Zn⁺²], which are coupled to changes in the ORR:

Zn↔Zn⁺²↔ZnOH⁺↔Zn(OH)₂

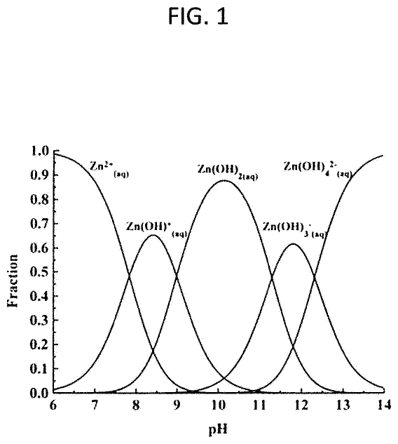

As the fuel cell matures, there is a rise in pH from approximately 6.5 to 8.5 and later to a pH of approximately 10. When this rise in pH occurs, the species of zinc metal ions in the electrolyte changes and often a milky precipitation appears. The relationship between pH and zinc species is described in FIG. 1. Also, small spacing between anode and cathode is beneficial for maximum efficiency.

### Photovoltaic Reduction of Metal Ions

Zn⁺² and ZnOH⁺ are primary metal cations in this ZAFC in the pH range of 6.5-8.5. Unexpectedly, these cations can be reduced with electrons from a photovoltaic cell. The ZAFC is easily rechargeable and can be overcharged. Also, zinc metal can be easily plated on graphite, copper, or zinc cathodes from samples of the electrolyte. Thus, the waste of this ZAFC can be readily reclaimed with energy from the sun, and the overall efficiency of electricity conversion is much high than an isolated ZAFC, which is approximately 58%.

Experimental and Theoretical Calculations

| Anode: Zn ↔ Zn⁺² + 2e⁻ | E = 0.76 V | |
|---|---|---|
| Cathode: O₂ + 2H₂O + 4e⁻ ↔ 4OH⁻ | E = 0.40 V | |
| Overall: | E = 1.16 V | |
| Initial E across 1K ohm resistor | 0.816 | pH = 6.8 |
| Mature E across 1K ohm resistor | 0.668 | pH = 8.1 |
| Efficiency = E observed/E theoretical | 0.668/1.16 = 58% | |

### Nernst Equation for the Anode Under Standard Conditions:

aA+mH⁺+ze⁻=bB+H₂0

E=E°+0.0591/z*log [A]^{a}/[B]^{b}−m/z*0.0591 pH

a=1; A=[Zn⁺²]; m=2; z=2; b=1; B=[Zn]

E=E°+0.0591/2*log [Zn⁺²]/[Zn]−0.0591*pH

As [Zn⁺²] decreases and pH increases, E will decrease, which describes the maturity of this ZAFC with ORR unchanged. However, reduction of Zn⁺² and ZnOH⁺ with recharging or reduction of Zn⁺² and ZnOH⁺ from the separated electrolyte and replacement of the electrolyte with seawater or saline will reestablish the function of the fuel cell to initial E. The reduction reactions are:

Zn⁺²+2e⁻↔Zn

ZnOH⁺+H⁺+2e⁻↔Zn+H₂O

If plated, zinc can be incorporated into a new anode. Therefore, the overall efficiency of the system will exceed 58%.

### Experimental Section

A ZAFC was constructed with zinc, graphite, and seawater or saline connected to a 1K ohm resistor. The initial pH and voltage of the cell was 6.9 and 0.816 which matured over time to 8.1 and 0.668 The cell was recharged with a 0.5 watt, 5 volt, 100 ma photovoltaic cell in sunlight to original conditions. The ZAFC can be easily overcharged with the photovoltaic cell to 2.35 V as measured across a 1K ohm resistor with a concomitant pH reduction to 6.8.

A graphite anode and graphite cathode, copper cathode, or zinc cathode was immersed in the electrolyte aspirated from the ZAFC, and the cations were reduced with a 0.5 watt, 5 volt, 100 ma photovoltaic in sunlight. In all instances, the plating of zinc onto the cathode was rapid. The solar reduction of Zn⁺² and ZnOH⁺ to reclaimed zinc metal could be incorporated into a subsequent zinc anode of a ZAFC. The plating of the zinc species is presumed to follow Faraday's Law of Electrolysis:

m=(Q/F)(M/z)

m=mass of substance plated on the electrode
Q=total electric charge transferred
F=Faraday constant
M=molecular weight of substance
Z=electrons transferred per ion

### Benefits to Society

Energy consumption per person continues to increase as more countries improve infrastructure and world population increases, leading to energy insecurity which is often a harbinger of conflict among nations. Coupling ZAFC electricity production with photovoltaic reduction of waste zinc species may provide a system of ARS electricity for the future.

### REFERENCES

1. Goldberg, J. S., Bhatt, A. M., ZINC AIR FUEL CELL FOR RENEWABLE AND STAINABLE ENERGY US 2022/0302485 A1.
2. Katsaiti, M., Papadogiannis, E., Dracopoul, V., et al, Solar charging of a Zn-air battery. Journal of Power Sources, 2023. 555.

Having described my invention, I claim:

1. A photovoltaic chemical reduction of a Zn⁺² species and a ZnOH⁺ species within an electrolyte of a zinc air fuel cell.

2. The zinc air fuel cell of claim 1 is comprised of zinc, graphite, and seawater or saline.
